(19) United States
(12) Patent Application Publication
(10) Pub. No.: US 2003/0082079 A1
(43) Pub. Date: May 1, 2003

(54) Laser heating micro reactor

(75) Inventor: Mitsuru Sawano, Ashigarakami-gun (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/277,904

(22) Filed: Oct. 23, 2002

(30) Foreign Application Priority Data
Oct. 26, 2001 (JP) P.2001-328918

(51) Int. Cl. G01N 21/00; G01N 1/10

(52) U.S. Cl. 422/100; 422/82.05; 422/82.09

(57) ABSTRACT

A micro reactor has a plurality of passages, and a joining path to which these plurality of passages are joined, and the wall surface at least in the vicinity of the reaction portion in the joining path is structured by the thin wall portion for the laser irradiation.

### BACKGROUND OF THE INVENTION

The present invention relates to a chemical reaction apparatus (micro reactor) by which the chemical reaction is reacted by mixing at least 2 liquids in the fine passage having a sectional area of not larger than 1 mm², and particularly to a micro reactor which can be heated from the outside.

In the conventional micro reactor, there is one in which 2 liquids are put in the in a small vessel (beaker or flask), and mixed by the eddy flow and the chemical reaction is reacted. Conventionally, in this kind of micro reactor, because it is the eddy flow mixing by such an agitation, a uniform mixing is difficult and results in that a particle whose crystal particle size is large, is produced, and the size is non-uniform, and the precision/uniformity of the crystal particle size is insufficient.

As the micro reactor to solve this, a laminar flow type micro reactor shown by an exploded perspective view in FIGS. 5A to 5D is developed. FIG. 5A is a perspective view showing the structure of a lid portion 1 of the conventional micro reactor. In the lid portion 1, a pipe 11 connected to a flow inlet in the vicinity of one side surface of the lid portion 1, a pipe 12 connected to the other flow inlet of the same, and a pipe 13 connected to a flow outlet in the vicinity of the opposite side surface of the lid portion 1, are respectively provided.

FIG. 5B is a perspective view showing the structure of a packing portion 2 of the micro reactor, and in the packing portion 2, flow inlets 21 and 22 penetrate in the vicinity of one side surface, and a flow outlet 23 penetrates in the vicinity of opposite side surface. Each flow inlet and flow outlet are structured in such a manner that the flow inlet 21 is connected to the pipe 11 of the lid portion 1, flow inlet 22 is connected to the pipe 12 of the lid portion 1, and the flow outlet 23 is connected to the pipe 13 of the lid portion 1, respectively.

FIG. 5C is a perspective view showing the structure of a main body portion 3′ of the micro reactor. In the main body portion 3′, flow inlets 31 and 32 are provided in the vicinity of one side surface and a flow outlet 33 is respectively provided in a situation that they have the bottom, and from each of flow inlets 31 and 32, each one of grooves 35 and 34 with the bottom extends toward the opposite side surface on approaching each other, and they are joined on the midway, and are formed into one joined groove (with the bottom) 36, and it extends to the flow outlet 33. They are provided in such a manner that the flow inlet 31 is connected to the flow inlet 21, and the flow inlet 32 is connected to the flow inlet 22, and the flow outlet 33 is connected to the flow outlet 23, respectively.

FIG. 5D is a perspective view showing the structure of a heating portion 4 of the micro reactor. The heating portion 4 is formed in such a manner that the peripheral 4 sides are formed high in the picture frame-like, and the center 45 is formed low, and a flow inlet 41 for hot water penetrates the heating portion 4 in the vicinity of one side surface of the central portion 45, and the flow outlet 42 respectively penetrates the heating portion 4 in the vicinity of the opposite side surface, and they are respectively connected to outside hose pipes 43 and 44.

Then, when the lid portion 1, packing portion 2, main body portion 3′, and heating portion 4 shown in FIGS. 5A to 5D are superimposed in this order and liquid tightly fixed, the laminar flow type micro reactor is completed. Then, when the liquid B and liquid A are respectively flowed into the pipe 11 and pipe 12, the liquids respectively pass the flow inlets 21 and 22, reach the flow inlets with the bottom 31 and 32, and further, pass the grooves 35 and 34, and are mixed in the joining groove 36, and reaches the flow outlet with the bottom 33 while chemically reacting, and further, passes the flow outlet 23, and the liquids (A+B) in which the reaction is completed, go out from the pipe 13. For that time, when the desired temperature hot water is flowed from the outside hose pipe 43, it passes from the flow inlet 41 to the central portion 45, and goes from the flow outlet 42 in the vicinity of the opposite side surface to the outside hose pipe 44. Thereby, the main body portion 3′ is heated, and the chemical reaction is accelerated.

According to such the conventional micro reactor, as compared to the micro reactor using the conventional flask, there are various characteristics, and even the reaction necessary for the accurate temperature control or the reaction necessary for the rapid heating or cooling, can be easily conducted. However, in the conventional micro rector, because it is for heating the whole apparatus, the heat is diffused to the structure other than the reaction material, and the heat goes to nothing as ever. Further, because the hot water is used, the liquid shielding structure is necessary and the apparatus becomes large, and also the operability is not so good. Further, even when the heating portion 4 by this hot water is replaced with a heating portion by an electric heater, because the heat is diffused to the structure other than the reaction material as ever, still the heat becomes useless.

### SUMMARY OF THE INVENTION

The present invention solves these drawbacks, and the object of the present invention is to provide a micro reactor by which the uniform mixing can be conducted, and only the reaction generation portion can be effectively heated.

In order to solve the above problems, the invention of a micro reactor according to the first aspect is characterized in that: the micro reactor has a plurality of passages and a joining path to which these plurality of passages are joined, and a wall surface in the vicinity of at least a reaction portion in the joining path is structured by a thin wall portion for the laser irradiation.

The invention of a micro reactor according to the second aspect is characterized in that: the micro reactor has a plurality of passages and a joining path to which these plurality of passages are joined, and a wall surface in the vicinity of at least a reaction portion in the joining path is structured by a light transmitting material for the laser irradiation.

The invention of a micro reactor according to the third aspect is characterized in that: in the micro reactor according to the second aspect of the invention, a portion of the light transmitting material structures a shape lens, grating lens, or slope refractive index lens.

The invention of a micro reactor according to the fourth aspect is characterized in that: in the micro reactor according to any one of the aspects 1-3, it has a laser light absorbing material in a joining path in the vicinity of reaction portion which is laser-irradiated.

The invention of a micro reactor according to the fifth aspect is characterized in that: in the micro reactor according to any one of aspects 1-4, the laser light absorbing material is a joining path wall surface.

The invention of a micro reactor according to the sixth aspect is characterized in that: in the micro reactor according to any one of aspects 1-5, the temperature of the reaction portion is controlled by the laser.

The invention of a micro reactor according to the seventh aspect is characterized in that: in the micro reactor according to the aspect 6, by intermittently conducting the laser irradiation, the reaction product material passing the joining path is modulated.

The invention of a micro reactor according to the eighth aspect is characterized in that: the micro reactor has a broad passage, a plurality of passages, and a joining path in which each exit of the plurality of passages is provided in the broad passage, and a wall surface, at least, in the vicinity of the reaction portion in the joining path is structured by a thin wall portion or light transmitting material for the laser irradiation.

The invention of a micro reactor according to the ninth aspect is characterized in that: the micro reactor has a plurality of passages, and a joining path in which each exit of the passages is structured by respective plurality of small exits, and the plurality of small exits are respectively alternately arranged, and a wall surface, at least, in the vicinity of the reaction portion in the joining path is structured by a thin wall portion or light transmitting material for the laser irradiation.

The invention of a method of use according to the tenth aspect is characterized in that: when the micro reactor according to any one of aspects 1-9 is used, the light absorbing material is mixed in at least one reaction liquid.

### BRIEF DESCRIPTION OF THE DRAWINGS

FIGS. 1A to 1C are exploded perspective views showing the structure of a micro reactor of the first embodiment of the present invention;

FIGS. 2A to 2D are plan views showing each example of a main body portion of FIG. 1C;

FIGS. 3A to 3D are exploded perspective views showing the structure of a micro reactor of the second embodiment of the present invention;

FIGS. 4A to 4C are exploded perspective views showing the structure of a micro reactor of the third embodiment of the present invention; and

FIGS. 5A to 5D are exploded perspective views showing the structure of a conventional micro reactor of laminar flow type.

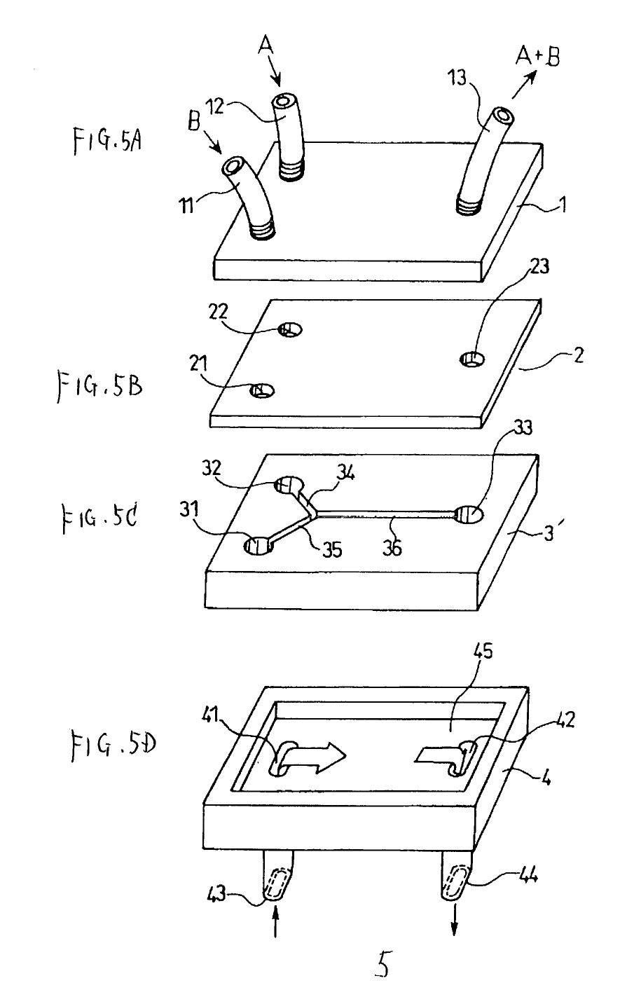

### DETAILED DESCRIPTION OF THE PREFERRED EMBODIMENT

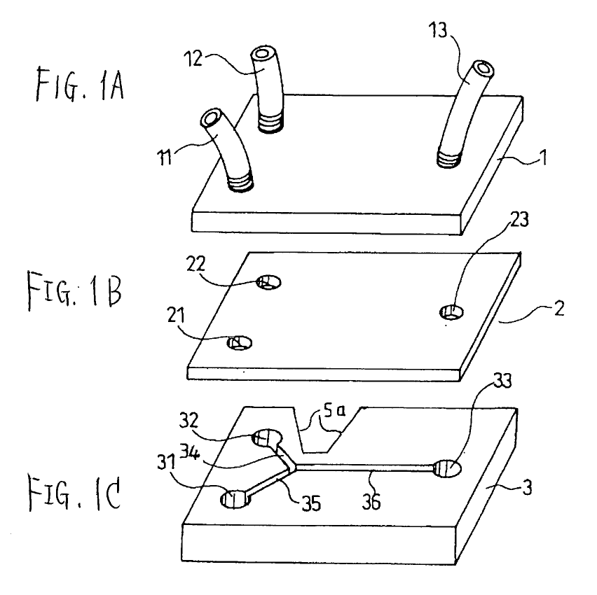

Referring to FIGS. 1A to 1C, a micro reactor of the present invention will be described below.

FIGS. 1A to 1C are exploded perspective views showing the structure of the micro reactor of the present invention. FIG. 1A is a perspective view showing the structure of a lid portion 1 of the micro reactor, and in the lid portion 1, a pipe 11 connected to the flow inlet in the vicinity of one side surface of the lid portion 1, the pipe 12 connected to the other flow inlet of the same, and the pipe 13 connected to the flow outlet in the vicinity of the opposite side surface of the lid portion 1, are respectively provided.

FIG. 1B is a perspective view showing the structure of a packing portion 2 of the micro reactor, and in the packing portion 2, the flow inlets 21 and 22 penetrate the vicinity of one side surface, and the flow inlet 23 is respectively penetrates the vicinity of the opposite side surface. Each flow inlet and flow outlet are provided in such a manner that the flow inlet 21 is connected to the pipe 11 of the lid portion 1, flow inlet 22 is connected to the pipe 12 of the lid portion 1, and flow outlet 23 is connected to the pipe 13 of the lid portion 1, respectively.

FIG. 1C is a perspective view showing the structure of the main body portion 3 according to the present invention. In the main body portion 3, the flow inlets 31 and 32 are provided in the vicinity of one side surface in the state having the bottom, and the flow outlet 33 is provided in the vicinity of the opposite side surface in the state having the bottom, and from each of flow inlets 31 and 32, each one of grooves with the bottom 35 and 34 extends toward the opposite side surface while approaching each other, and they are joined on the midway and formed into one joining groove (with the bottom) 36, and it extends to the flow outlet 33. Each flow inlet and flow outlet are provided in such a manner that the flow inlet 31 is combined with the flow inlet 21, the flow inlet 32 is combined with the flow inlet 22, and the flow outlet 33 is combined with the flow outlet 23, respectively. The groove is 10 μm in the width, and 100 μm in the depth. Then, a cutout 5a according to the present invention is formed in the main body portion 3.

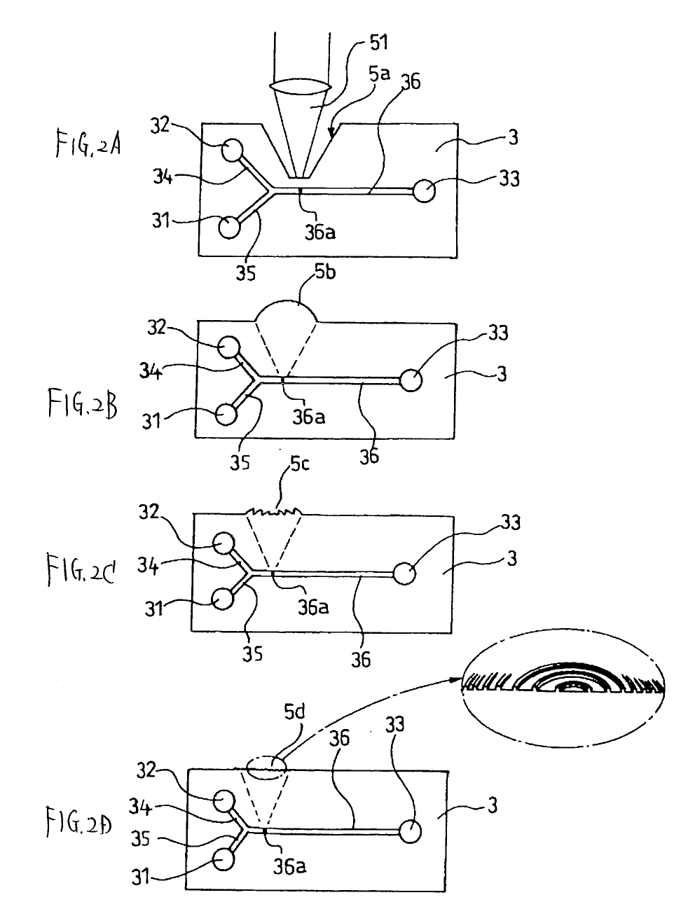

FIG. 2A shows the first embodiment of the present invention, and is a plan view of the main body portion 3 in which the cutout 5a is formed. In FIG. 2A, the cutout 5a is formed in such a manner that it approaches the vicinity of the joined point at which the groove 35 from the flow inlet 31 and the groove 34 from the flow inlet 32 are joined. For the material of the main body portion, SUS, aluminum or glass is used. The partition wall from the leading edge of the cutout 5a to the joined groove 36 is made of thin wall of about 10 μm, and has the length of about 100 μm along the joined groove 36. Numeral 51 is a laser light stopped down by the lens, and its focal point is focused onto a reaction portion 36a of the joined groove 36. The wavelength of the laser is 1064 nm, and the power is 1 W, and the CW laser is irradiated by being stopped down to 100 μmφ. The width of the joined groove 36 is 10 μm and narrow, and also the heating range is 100 μm and long. By such the structure, the laser light 51 heats only the reaction portion 36a of the joined groove 36. Then, simultaneously when the liquid B and liquid A which are respectively flowed from the flow inlets 31 and 32 in the grooves 35 and 34 are joined at the joined groove 36 and start the reaction, because the vicinity of the reaction portion 36a is heated by the laser light 51 from the outside, in the liquid which passes the reaction portion 36a, the liquid A and liquid B are uniformly mixed and sufficiently heated, and although the heating energy is small, the chemical reaction can be effectively made.

FIGS. 2A to 2D are examples showing each kind of structures of the main body portion 3 in FIG. 1C. FIG. 2A is an example in which the cutout 5a is provided, and already explained in FIG. 1C. FIG. 2B is the first modified example of the first embodiment of the present invention in place of the cutout 5a in FIG. 2A. Numeral 5b is a shape lens (convex lens) and its material is the light transmitting material such as glass or transparent plastic. The focal point of the shape lens 5b is focused onto the reaction portion 36a of the joined groove 36. By such the structure, because the laser light 51 can heat only the reaction portion 36a of the joined groove 36, the liquid B and liquid A which are respectively flowed from the flow inlets 31 and 32 in the grooves 35 and 34 are joined at the joined groove 36 and start the reaction. Then, when the vicinity of the reaction portion 36a is heated by the laser light 51 from the outside, the chemical reaction is rapidly accelerated. Because the width of the joined groove 36 is 10 μm and narrow, and the heating range is also 100 μm and long, in the liquid which passes the reaction portion 36a, the liquid A and liquid B are uniformly and sufficiently heated, and although the heating energy is small, the chemical reaction can be effectively made.

FIG. 2C is the second modified example of the first embodiment of the present invention instead of the cutout 5a in FIG. 2A. Numeral 5c is the Fresnel lens and its material is the light transmitting material such as glass or transparent plastic. The focal point of the Fresnel lens 5c is focused onto the reaction portion 36a of the joined groove 36. By such the structure, because the laser light 51 heats only the reaction portion 36a of the joined groove 36, the liquid B and liquid A which are respectively flowed from the flow inlets 31 and 32 in the grooves 35 and 34 are joined at the joined groove 36 and start the reaction. Then, when the vicinity of the reaction portion 36a is heated by the laser light 51 from the outside, the chemical reaction is rapidly accelerated. Because the width of the joined groove 36 is 10 μm and narrow, and the heating range is also 100 μm and long, in the liquid which passes the reaction portion 36a, the liquid A and liquid B are uniformly and sufficiently heated, and although the heating energy is small, the chemical reaction can be effectively made.

FIG. 2D is the third modified example of the first embodiment of the present invention instead of the cutout 5a in FIG. 2A. Numeral 5d is a grating lens and its material is the light transmitting material such as glass or transparent plastic. The focal point of the grating lens 5d is focused onto the reaction portion 36a of the joined groove 36. By such the structure, because the laser light 51 heats only the reaction portion 36a of the joined groove 36, the liquid B and liquid A which are respectively flowed from the flow inlets 31 and 32 in the grooves 35 and 34 are joined at the joined groove 36 and start the reaction. Then, when the vicinity of the reaction portion 36a is heated by the laser light 51 from the outside, the chemical reaction is rapidly accelerated. Because the width of the joined groove 36 is 10 μm and narrow, and the heating range is also 100 μm and long, in the liquid which passes the reaction portion 36a, the liquid A and liquid B are uniformly and sufficiently heated, and although the heating energy is small, the chemical reaction can be effectively made.

Other than that, although not specifically illustrated, as the fourth modified example instead of the cutout 5a in FIG. 2A, it is also possible that the laser light irradiation portion is formed of the slope refractive index lens. The slope refractive index lens may be well known one, and for example, the lens disclosed in Japanese Patent Publication No. Hei. 9-174932 can be used. By such the structure, because the laser light 51 heats only the reaction portion 36a of the joined groove 36 through the slope refractive index lens, the liquid B and liquid A which are respectively flowed from the flow inlets 31 and 32 in the grooves 35 and 34 are joined at the joined groove 36 and start the reaction. Then, when the vicinity of the reaction portion 36a is heated by the laser light 51 from the outside, the chemical reaction is rapidly accelerated. Because the width of the joined groove 36 is 10 μm and narrow, and the heating range is also 100 μm and long, in the liquid which passes the reaction portion 36a, the liquid A and liquid B are uniformly and sufficiently heated, and although the heating energy is small, the chemical reaction can be effectively made.

As described above, although the wall surface in the vicinity of the reaction portion is structured of the light transmitting material for the laser irradiation, and a portion of the light transmitting material forms the shape lens, grating lens or slope refractive index lens, alternatively, it is also effective that the vicinity of the joining path in the vicinity of the reaction portion, particularly, the joining path wall surface has the laser light absorbing material, for example, the metal such as aluminum. Then, by controlling the temperature of the reaction portion by the laser, it can be maintained at the desired reaction temperature.

Further, by making the laser irradiation intermittent, the modulation in which the reaction product which passes the joining path has the reaction portion and the non-reaction portion, can be added.

Further, when the light absorbing material such as the dye is mixed in the reaction liquid, because the absorption of the laser light of the reaction liquid becomes good, the chemical reaction can be carried out with good thermal efficiency.

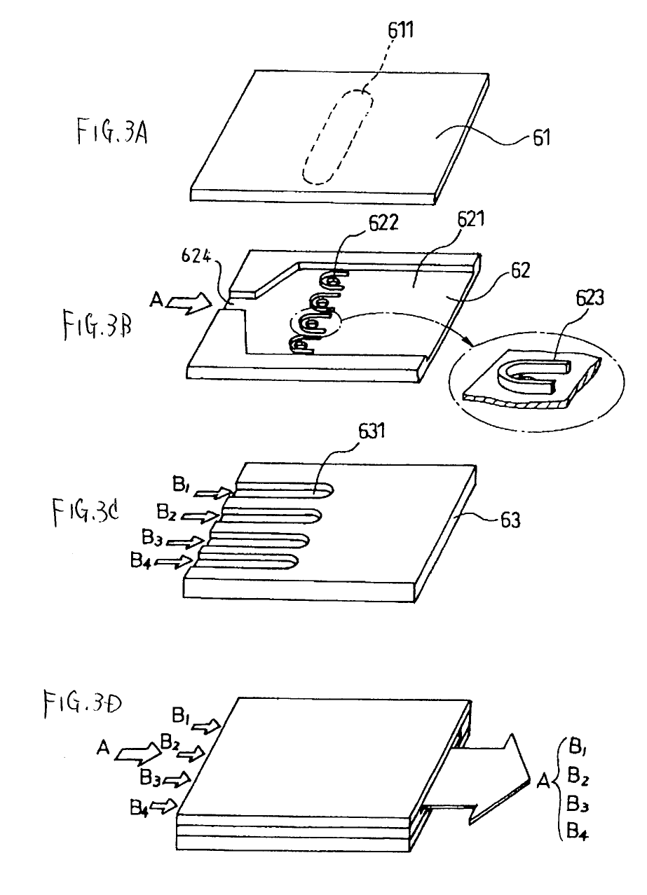

FIGS. 3A to 3D are exploded perspective views showing the structure of the micro reactor of the second embodiment of the present invention. The micro reactor of the second embodiment is the reactor in which the contact surface of 2 liquids (liquid A and liquid B) is increased, the passage of the liquid A is structured broad, the passage of the liquid B is structured as a plurality of passages (B1, B2, B3, B4), each of the outlets of the plurality of passages is structured in the passage of the liquid A, and the wall surface in the vicinity of the reaction portion is structured by the thin wall portion or light transmitting material for the laser irradiation.

FIG. 3A is a perspective view showing the structure of a lid portion 61 of the micro reactor, and in the lid portion 61, a work 611 by which the reaction portion, which will be described later, is irradiated by the laser, is provided. Relating to the work 611, it will be described later. As the material, glass or SUS is appropriately selected and used corresponding to the purpose.

FIG. 3B is a perspective view showing the structure of the main body portion 62 of the micro reactor. In the main body portion, a flow inlet passage 624 of the first liquid (liquid A) and a broad passage 621 connecting to the flow inlet passage 624 are provided. In the broad passage 621, a plurality of through holes 622 (four through holes shown in FIG. 3B) are bored in the perpendicular direction to the flow direction. Then, a U-shaped screen 623 stands in such a manner that the through holes 622 are surrounded, and in this case, because it is structured so that the U- shaped screen surrounds the upstream side of the through holes 622, and the downstream side is opened, the mixture of the second liquid which comes from the through holes 622 with the first liquid is smoothly conducted by the action of this screen, and the eddy flow is not generated. In the view, in order to easily be understood, the broad scale is used in the width direction, however, actually, it is compressed in the width direction, and the interval between mutual through holes 622 is formed in microns-order and narrow so that the laminar flow is obtained.

FIG. 3C is a perspective view showing the structure of a passage member for the second liquid of the micro reactor, and in the passage member for the second liquid 63, a plurality of second liquid passages 631 (four second liquid passages shown in FIG. 3C) are provided. Each of the second liquid passages 631 is structured in such a manner that it comes to the end of the passage on the midway of flow direction of the second liquid-use passage member 63, and when the main body portion 62 is tightly superimposed and fixed on the second liquid-use passage member 63, the second liquid (B1, B2, B3, B4) which is flowed in each of passages 631 of the second liquid-use passage member 63 changes its direction from here toward the perpendicular upper direction, and passes the through hole 622 of the main body portion 62 and flows toward the downstream direction in the broad passage 621 of the main body portion 62.

FIG. 3D is a perspective view of the micro reactor in which each member of FIGS. 3A to 3C is superimposed in this order and liquid tightly fixed. When the first liquid (liquid A) is flowed into the flow inlet passage 624 (FIG. 3B), on the one hand, the second liquid (B1, B2, B3, B4) is flowed into each passage 631 (FIG. 3C), 2 liquids are smoothly mixed without eddy flow at near the outlet portion of the through hole 622 of the main body portion 62, as described above, and flow to the downstream direction of the broad passage 621 while making the chemical reaction (A+B1 to B4).

Herein, the above-described work 611 (FIG. 3A) will be detailed. The work 611 is conducted according to the same principle as ones described in FIGS. 2A to 2D. However, FIGS. 2A to 2D are plan views of the packing portion 2 of FIG. 1, herein, the reading of FIGS. 2A to 2D is changed to the front cross sectional view of the lid portion 61 of FIG. 3A. That is, the first example of the work 611 is a work in which the cutout 5a as shown in FIG. 2A is formed from the front surface of the lid portion 61 toward the lower inside. The cutout 5a is formed in such a manner that it approaches the reaction portion in the vicinity of the downstream side of the through hole 622 at which the liquid A and the liquid B are joined. The partition wall from the leading edge of the cutout 5a to the reaction portion (36a of FIGS. 2A to 2D) is formed of the thin wall of thickness of about 10 μm, and of the length of 100 μm along the joining groove 36.

Numeral 51 is the laser light which is stopped down by the lens, and the focal point is focused on the reaction portion 36a. The wavelength of the laser is 1064 nm, the power is 1 W, and the CW laser is stopped down to 100 μmφ and the depth of the focus is made deep, and the laser is irradiated. By such the structure, because the only the reaction portion 36a is heated by the laser light 51, the liquid A and the liquid B start the reaction in the vicinity of the joining point. Accordingly, by heating only the vicinity of the reaction portion 36a by the laser light 51 from the outside, although the heating energy is small, the chemical reaction can be effectively made.

FIG. 2B is the first modified example of the work 611 of the second embodiment of the present invention in place of the cutout 5a of FIG. 2A, and is a shape lens (convex lens) 5b. The material of the shape lens 5b is the light transmitting material such as glass, or transparent plastic. The focal point of the shape lens 5b is focused onto the reaction portion 36a.

FIG. 2C is the second modified example of the work 611, and the Fresnel lens 5c. Its material is the light transmitting material such as glass, or transparent plastic. The focal point of the Fresnel lens 5c is focused onto the reaction portion 36a of the joining groove 36.

FIG. 2D is the third modified example of the work 611, and the grating lens 5d. Its material is the light transmitting material such as glass, or transparent plastic. The focal point of the grating lens 5d is focused onto the reaction portion 36a.

Other than that, as the fourth modified example of the work 611, the laser light transmission portion can also be formed by the slope refractive index lens.

By heating only the vicinity of the reaction portion by the laser light from the outside through such a work, although the heating energy is small, the chemical reaction can be effectively made.

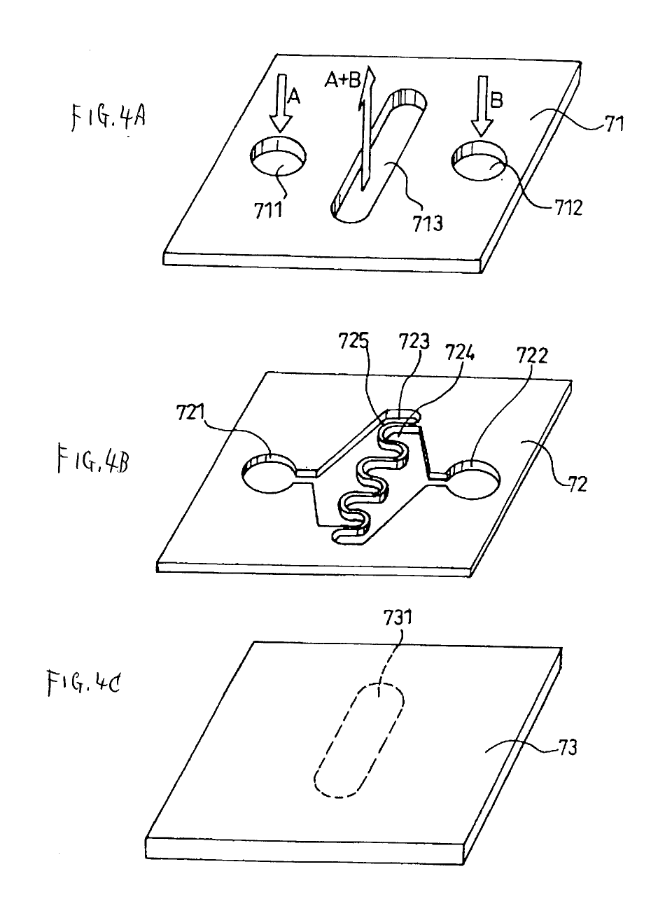

FIGS. 4A to 4C are exploded perspective views showing the structure of the micro reactor of the third embodiment of the present invention. The micro reactor of the third embodiment is one in which the contact area of 2 liquids (liquid A and liquid B) is increased.

FIG. 4A is a perspective view showing the structure of a lid portion 71 of the micro reactor, and a first liquid (liquid A) inflow port 711 and a second liquid (liquid B) inflow port 712, and a discharge port 713 of the mixing liquid (reaction liquid) A+B at the intermediate position between the both liquid inflow ports 711 and 712, respectively pass through the lid portion 71 and are opened. As the material, glass or SUS is appropriately selected and used corresponding to the purpose.

FIG. 4B is a perspective view showing the structure of the main body portion 72 of the micro reactor, and through the main body portion 72, the through hole 721 connecting to the inflow port 711 (FIG. 4A) of the first liquid, through hole 722 connecting to the inflow port 712 (FIG. 4A) of the second liquid, and wide mouthed through holes 723, 724 from which the mixed liquid (reaction liquid) A+B is discharged at the intermediate position between the through hole 721 and the through hole 722, respectively pass and are opened. The wide mouthed through holes 723 and 724 are respectively divided into the wide mouthed through holes 723 and 724 by a meandering partition wall 725 extending toward the perpendicular direction to the flow direction. Accordingly, the advancing of the liquid of the through hole 721 is blocked by the meandering partition wall 725 on the wide mouthed through hole 723 side, and the liquid goes upward along the meandering partition wall 725. In the same manner, the advancing of the liquid of the through hole 722 is blocked by the meandering partition wall 725 on the wide mouthed through hole 724 side, and the liquid goes upward along the meandering partition wall 725.

The above-described mixed liquid discharging hole 713 (FIG. 4A) is structured such that it is arranged on the meandering partition wall 725.

FIG. 4C is a perspective view showing the structure of a bottom portion 73 of the micro reactor, and on the bottom portion 73, a work 731 by which the reaction portion can be laser-irradiated, is provided. For the work 731, the same structured one as the work 611 of FIG. 3A is used. That is, it is formed of the shape lens (convex lens), Fresnel lens, grating lens, or slope refractive index lens, and the focal point may be made to focus onto the reaction portion.

Further, instead of a case where the work 731 is provided on the bottom portion 73, the work as shown in FIG. 2 may be provided on the lid portion 71 side of the micro reactor. In this case, when the irradiation section is insufficient in the flow direction, a plurality of optical systems maybe provided in the flow direction.

In the view, in order to be easily understood, the broad scale in the width direction is used, but, actually, it is compressed in the width direction, and the interval of mutual through holes 622 is microns-order so that the laminar flow can be obtained.

Then, when each of members in FIGS. 4A to 4C is superimposed in this order, and liquid tightly fixed, the micro reactor of the third embodiment can be obtained. Then, when the first liquid (liquid A) is flowed into the inflow port 711 (FIG. 4A), on the one hand, the second liquid (liquid B) is flowed into inflow part 712 (FIG. 4A), the advancing of 2 liquids are blocked by the meandering partition wall 725 as described above, in the wide mouthed through holes 723 and 724 of the main body portion 72, and the liquid goes upward along the meandering partition wall 725, and both liquids are smoothly mixed without eddy flow, and meanwhile, because only the joined portion is laser-heated by the work 731 from the lower side, the liquid is taken out from the mixed liquid discharging hole 713 (FIG. 4A) while accelerating the chemical reaction. As described above, because only the reaction portion is heated by the laser light, although the heating energy is small, the chemical reaction can be effectively made.

Also in each of the above second and third embodiments, when, in the vicinity of the joining path in the vicinity of the reaction portion, particularly, on the joining path wall surface, the laser light absorbing material, for example, the metal such as aluminum is provided, it is also effective. Then, by controlling the temperature of the reaction portion by the laser, it can be maintained at the desired reaction temperature.

Further, by making the laser irradiation intermittent, the modulation in which the reaction product which passes the joining path is a repetition of the reaction portion of the desired length and the non-reaction portion, can be added.

Further, when the light absorbing material is mixed in the reaction liquid, because the absorption of the laser light of the reaction liquid becomes good, the chemical reaction can be carried out with the small heating energy and efficiently.

As described above, the present invention is a micro rector which has a plurality of passages and a joining path to which these plurality of passages are joined, and by structuring a wall surface at least in the vicinity of a reaction portion in the joining path by a thin wall portion for the laser irradiation, the micro device which has good thermal efficiency, good responsibility, and easy reaction control, can be obtained.

What is claimed is:

1. A micro reactor comprising:
a plurality of passages; and
a joining path to which said plurality of passages are joined,
wherein a wall surface in the vicinity of at least a reaction portion in the joining path is structured by a thin wall portion for the laser irradiation.

2. The micro reactor as claimed in claim 1, further comprising a laser light absorbing material provided in the vicinity of reaction portion to be laser-irradiated.

3. The micro reactor as claimed in claim 2, wherein said laser light absorbing material is provided in a wall surface of said joining path.

4. The micro reactor as claimed in claim 1, wherein the temperature of the reaction portion is controlled by the laser.

5. The micro reactor as claimed in claim 4, wherein a reaction product material passing the joining path is modulated by intermittently conducting the laser irradiation.

6. The micro reactor as claimed in claim 1,
wherein said plurality of passages comprise a first passage having wide width and a plurality of second passages,
wherein said joining path is disposed in said first passage.

7. The micro reactor as claimed in claim 1,
wherein each exit of said plurality of passages is structured by a plurality of small exits,
wherein said joining path is provided by alternately arranging said plurality of small exits.

8. A micro reactor comprising:
a plurality of passages; and
a joining paths to which said plurality of passages are joined,
wherein a wall surface in the vicinity of at least a reaction portion in the joining path is structured by a light transmitting material for the laser irradiation.

9. The micro reactor as claimed in claim 8, wherein a part of the light transmitting material is formed of one of a shape lens, grating lens, and slope refractive index lens.

10. The micro reactor as claimed in claim 8, further comprising a laser light absorbing material provided in the vicinity of reaction portion to be laser-irradiated.

11. The micro reactor as claimed in claim 10, wherein said laser light absorbing material is provided in a wall surface of said joining path.

12. The micro reactor as claimed in claim 8, wherein the temperature of the reaction portion is controlled by the laser.

13. The micro reactor as claimed in claim 12, wherein a reaction product material passing said joining path is modulated by intermittently conducting the laser irradiation.

14. The micro reactor as claimed in claim 8,
wherein said plurality of passages comprise a first passage having wide width and a plurality of second passages,
wherein said joining path is disposed in said first passage.

15. The micro reactor as claimed in claim 8,
wherein each exit of said plurality of passages is structured by a plurality of small exits,
wherein said joining path is provided by alternately arranging said plurality of small exits.

16. A method of use of the micro reactor as claimed in claim 1, wherein the light absorbing material is mixed in at least one reaction liquid.

17. A method of use of the micro reactor as claimed in claim 8, wherein the light absorbing material is mixed in at least one reaction liquid.
